(19) United States
(12) Patent Application Publication
(10) Pub. No.: US 2016/0096732 A1
(43) Pub. Date: Apr. 7, 2016

(54) METHOD OF PRODUCING HIGH PURITY OXYGEN

(71) Applicants: Shiguang LI, Mount Prospect, IL (US); Shaojun Zhou, Palatine, IL (US); Howard S. Meyer, Hoffman Estates, IL (US); Miao Yu, Pittsford, NY (US)

(72) Inventors: Shiguang LI, Mount Prospect, IL (US); Shaojun Zhou, Palatine, IL (US); Howard S. Meyer, Hoffman Estates, IL (US); Miao Yu, Pittsford, NY (US)

(21) Appl. No.: 14/870,906

(22) Filed: Sep. 30, 2015

Related U.S. Application Data
(60) Provisional application No. 62/058,194, filed on Oct. 1, 2014.

(51) Int. Cl. C01B 13/02; B01D 11/04

(52) U.S. Cl. CPC C01B 13/0285; B01D 11/0415

(57) ABSTRACT

A highly cost-efficient method and process for producing oxygen from a gaseous mixture such as air results in substantial energy savings compared to conventional methods. The gaseous mixture is fed to a membrane absorber in which oxygen from the gas is absorbed, through a first membrane by an oxygen-absorbing liquid that possesses suitable absorption and desorption properties. The resulting oxygen-rich carrier liquid is fed to a membrane desorber in which oxygen from the liquid is desorbed through a second membrane, suitably with the aid of a vacuum. The oxygen product suitably has greater than 95% purity, or greater than 99% purity.

### CROSS REFERENCE TO RELATED APPLICATION(S)

This application claims the benefit of U.S. Provisional Patent Application Ser. No. 62/058,194, filed on 1 Oct. 2014. The co-pending Provisional Application is hereby incorporated by reference herein in its entirety and is made a part hereof, including but not limited to those portions which specifically appear hereinafter.

### FIELD OF THE INVENTION

This invention is directed to an improved method of producing high purity oxygen from air.

### BACKGROUND OF THE INVENTION

Known techniques for producing oxygen from air require high pressure compression, often followed by significant heating (for separation using Ion transport membranes) or cooling (for cryogenic separation). In cryogenic separation (the most common process), pure gases can be separated from air by first cooling it mail it liquefies, then selectively distilling the components at their various boiling temperatures. Converting air to a liquid state requires a large amount of refrigeration and/or compression. While cryogenic distillation can produce oxygen having more than 99% purity, the oxygen production typically costs more than $35 per ton of oxygen.

Adsorption processes (for example, pressure swing adsorption) can provide up to 95% oxygen purity, but their high capital costs limit their usefulness for large scale oxygen production. A zeolite is exposed to high pressure air and selectively adsorbs the oxygen. Then the an is released and the adsorbed oxygen is separately released.

Conventional gas separation membrane processes (gas(es) on both sides of the membrane) using polymers, operate by a solution/diffusion mechanism, are relatively simple and energy efficient, but typically yield only about 40% oxygen purity. Ion transport membranes that exhibit high oxygen ionic and electronic conductivities gained great interest as clean and efficient means of producing oxygen from air or other oxygen-containing gas mixtures. They are developmental and can produce greater than 99% oxygen purity. However, the material and energy costs are high. The membrane fabrication requires temperatures exceeding 1100° C. and the oxygen separation requires temperatures exceeding 700° C.

Other processes are also under development, including magnetic processes that use magnetic beads, and bio-mimetic processes that mimic hemoglobin. There is a need or desire for a process for producing oxygen that can be used commercially in large scale operations with improved cost efficiency.

### SUMMARY OF THE INVENTION

The present invention is directed to a method of producing gas from an oxygen-containing gas such as air. The method includes the steps of feeding a gas including nitrogen and oxygen to the first side of a first membrane; feeding an oxygen-absorbing solvent to a second side old he first membrane; and passing the oxygen through the first membrane, from the first side to the second side of the first membrane, where the oxygen is absorbed by the oxygen-absorbing solvent to form an oxygen-rich carrier solution. The method further includes the steps of feeding the oxygen-rich carrier solution to a first side of a second membrane; passing the oxygen from the oxygen-rich carrier solution through the second membrane, from the first side to a second side of the second membrane; and recovering the oxygen from the second side of the second membrane.

The first and second membranes are suitably in the form of multiple small, porous, hydrophobic membrane tubes, and are contained in first and second membrane separator units referred to herein as a membrane absorber and a membrane desorber, respectively. The oxygen-containing gas is fed into the bore side of each of the membrane tubes under slight pressure, and the oxygen-absorbing solvent is fed to the shell side in the first membrane separator unit, which serves as the membrane absorber. The oxygen passes through the pores and is selectively absorbed by the oxygen-absorber solvent. The resulting oxygen-rich solution is then fed to the shell side in the second membrane separator unit, which serves as the membrane desorber and also includes a plurality of small, porous, hydrophobic membrane tubes. The oxygen passes enough the micropores with the aid of a vacuum pulled on the bore side of the membrane tubes, and passes to the bore side of the membrane tubes. The oxygen has a high purity of greater than 95%, typically greater than 99%, and is recovered from the bore side of the membrane tubes for further processing or use.

Based on present estimates, the method of the invention can produce oxygen from air on a large scale, at a significant cost reduction (up to 40% or more) compared to conventional, cryogenic distillation processes. The method of the invention entails significant reductions in energy and capital costs.

### BRIEF DESCRIPTION OF THE DRAWINGS

FIG. 1 is a schematic overview of a membrane contactor process for practicing the method of the invention, including a membrane absorber end a membrane desorber.

FIG. 2 is a partial cutaway view of a membrane absorber, showing the plurality of hydrophobic microporous membrane tubes.

FIG. 3 is a partial cutaway view of a membrane desorber.

FIG. 4 is an exploded sectional view of one portion of a wall of a hydrophobic microporous membrane tube, as used in a membrane absorber, with the symbols “P” standing for pressure.

FIG. 5 is an exploded sectional view of one portion of a wall of a hydrophobic microporous membrane tube, as used in a membrane desorber with the symbols “P” standing for pressure.

### DETAILED DESCRIPTION OF THE INVENTION

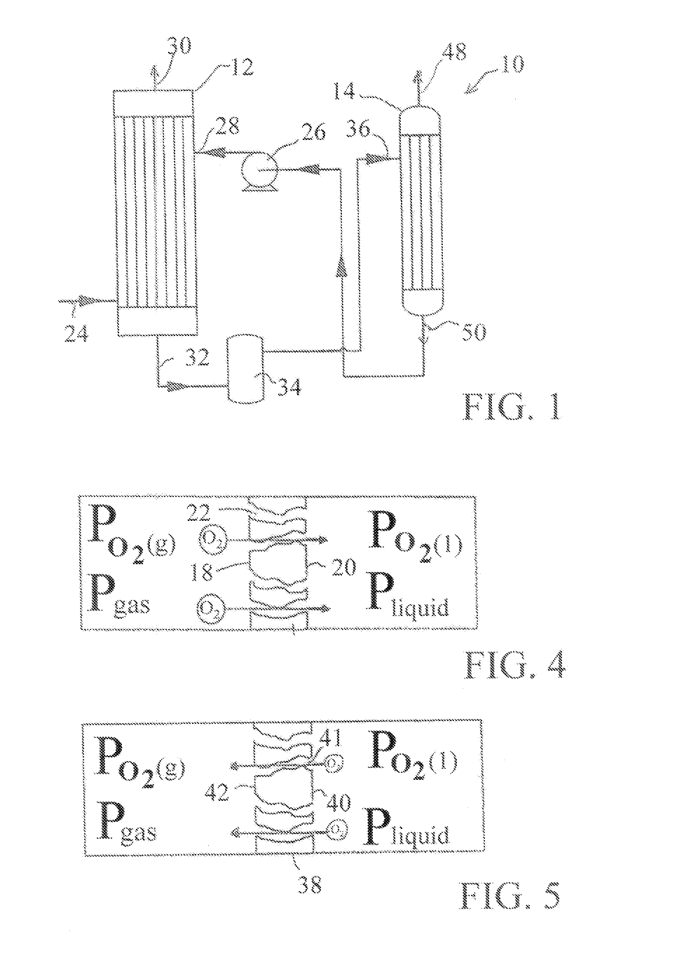

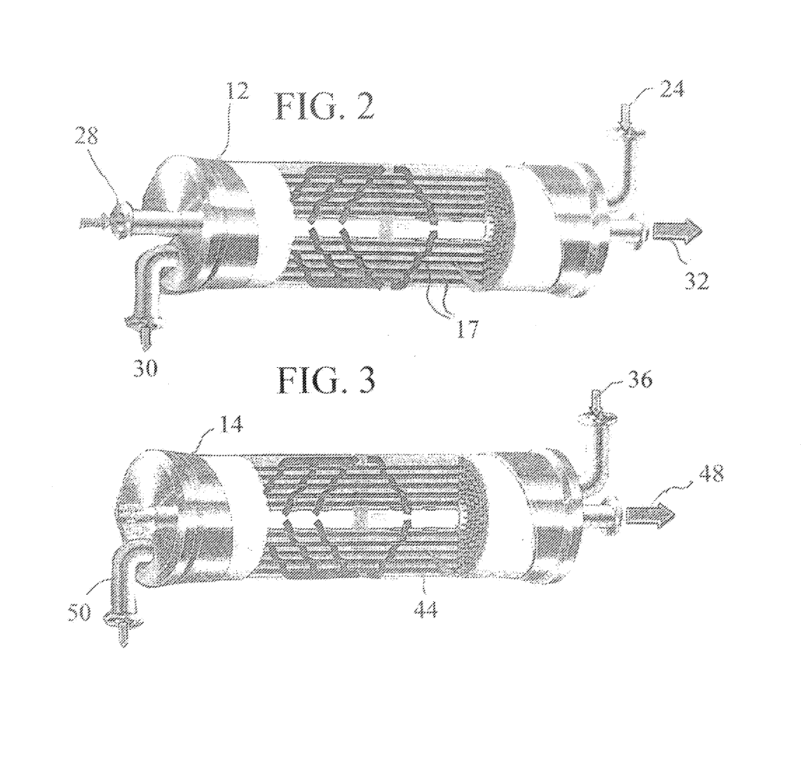

Referring to the drawings, a process 10 of the invention is used to produce oxygen from an oxygen-containing gas, such as air. The process 10 includes as its main elements, a membrane absorber 12 and a membrane desorber 14 (FIG. 1). The membrane absorber 12 includes one or more first membranes 16, each having a first side 18 and a second side 20 (FIG. 4). Suitably, the membrane absorber 12 includes a plurality (i.e. a large number) of first membranes 16 formed as hollow membrane tubes 17, with the first side 18 being the bore side and the second side 20 being the shell side of the membrane tubes 17. (FIGS. 2 and 4).

Each of the first membranes 16 is suitably formed of a hydrophobic microporous material whose pore size and hydrophobic nature enable the passage of oxygen but not aqueous liquid. Suitable hydrophobic materials include without limitation polyether ether ketone, polypropylene, and polytetrafluoroethylene (PTFE). These materials can be manufactured in hollow fiber forms using a high temperature melt extrusion process. The micropores 22 (FIG. 4) should be large enough to permit the free transfer of oxygen molecules, which have a molecular diameter of approximately 2.9-3.6 Angstroms, depending on the measurement technique.

For successful operation of the contactor process, it is desired that a) aqueous liquid is prevented from penetration into and passing through the micropores 22, and b) unimpeded transport of O₂ from the first side 18 to the second side 20 can occur. The first requirement can be satisfied if the membrane surface is sufficiently oleophobic (very ion surface energy) such trial no aqueous liquid can wet out and wick by capillary threes into the micropores 22 (requiring a contact angle between the liquid and solid phases of greater than 90°), and the surface tensions of the liquid phases are sufficiently high that the capillary penetration pressure of liquid into a micropore is well in excess of the maximum pressure difference across the membrane that might be encountered in the operation. Liquid penetration into the micropores 22 will lead to a dramatic decrease in mass transfer coefficient. The critical penetration pressure is defined by the classical Kelvin Equation:

Δp=2γ cos θ/r (1)

wherein Δp is the pore-entry pressure, γ is the liquid surface tension, θ is the contact angle, and r is pore radius. The higher the surface tension of the liquid, the larger the contact angle (in excess of 90°), and the smaller the micropore radios, the greater the intrusion pressure. There is a delicate balance between micropore wettability and membrane mass transfer resistance,

Each first membrane 16 (whether or not in tube form) may have an exemplary wall thickness not greater than about 0.25 mm, suitably about 0.07-0.12 mm. When each first membrane 16 is in the form of a membrane tube 17, the membrane tubes 17 can have an exemplary outer diameter not greater than about 1.5 mm, suitably about 0.4-0.7 mm. One reason for forming the first membranes 16 as small membrane tubes 17, and for placing many of the membrane tubes close together in the membrane absorber 12 (FIG. 2) is to maximize the surface area for oxygen transfer through the first membranes 16. The membrane tubes 17 shown in the membrane absorber 12 (FIG. 2) can have an area 1 packing density of at least about 500 m²/m³, suitably about 1000-5000 m²/m³.

An oxygen containing gas enters the membrane absorber 12 through inlet 24 and is channeled to the first side 18 of the one or more first membranes 16, which is sun ably the bore side of the plurality of membrane tubes 17. While the oxygen-containing gas may have a variety of compositions, the described process 10 is tailored to an oxygen-containing gas. Air is an oxygen-containing gas that includes about 79% nitrogen and about 21% oxygen. The oxygen-containing gas can be fed to the first side 18 of each first membrane 16 at a temperature ranging from ambient to slightly elevated (about 20-50° C.) and a slightly elevated pressure (P_{gas}, which includes Po_{2(g)}) of up to about 5 psig, suitably about 1-2 psig. These conditions facilitate oxygen-containing gas flow through each first membrane 16 (which can be a tube 17 sometimes called a hollow fiber), from the first side 18 to the second side 20 of the membrane 16 for absorption by an oxygen-absorbing solvent, without facilitating a similar transfer of the relatively inert nitrogen molecules. The oxygen absorbing solvent can reach an equilibrium pressure (P liquid) only by absorbing a sufficient amount of oxygen (designated by Po₂₍ᵢⱼ₎).

An oxygen-absorbing solvent (i.e. a solvent that selectively absorbs oxygen) is fed by a pump 26 to the membrane absorber 12 via an inlet 28 and is channeled to the second side 20 of the one or more first membranes 16, which is suitably the shell side of the plurality of membrane tubes 17. The oxygen-absorbing solvent is suitably an aqueous solution of a compound that has a high oxygen binding capacity and a favorable oxygen desorption equilibrium, i.e. an ability to reversibly bind a large amount of oxygen and low nitrogen binding capacity, i.e. nitrogen transfer into the solvent is limited to solubility only. Suitable oxygen-absorbing compounds include without limitation cobalt-based oxygen carriers, including poly(ethyleneimine)-cobalt, cobalt porphyrins, cobalt porphyrin complexes, and combinations thereof. Following are molecular structures for a) poly(ethyleneimine)-cobalt and b) two cobalt porphyrins, respectively.

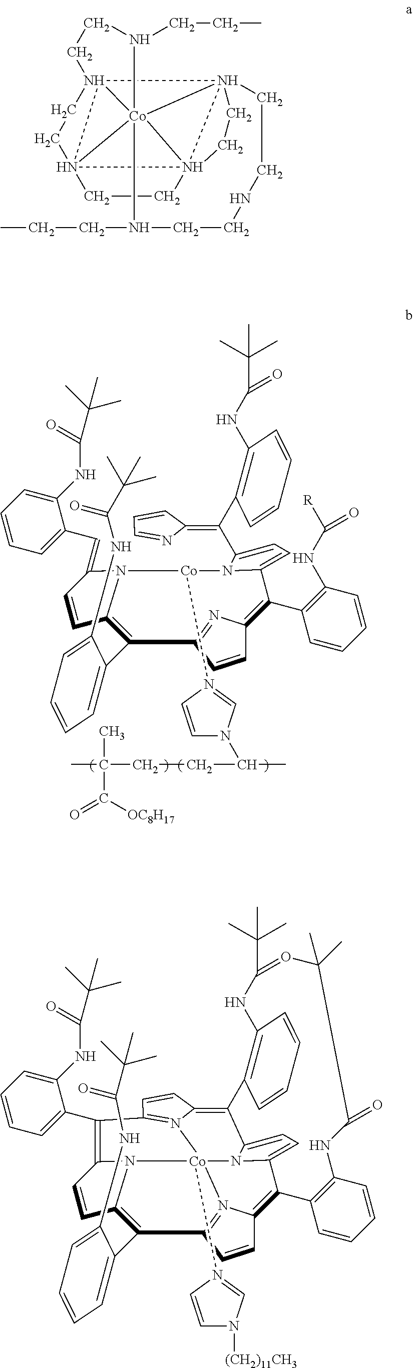

The cobalt-based oxygen carriers ate suitably dissolved in water to form the oxygen-absorbing solvent. The concentration of cobalt-based oxygen carrier in the water can range from about 0.001-0.025 mole per liter, suitably about 0.005-0.012 mole per liter, depending on its solubility. The following table shows the oxygen absorbing capacity at standard (ambient) temperature and pressure, and the oxygen desorption equilibrium for aqueous solutions of three cobalt-based oxygen carrier compounds in a concentration of 0.008 mole per liter. P₉₅ (KFa), is the equilibrium pressure at 95% saturation capacity. P₉₅ and the oxygen absorbing capacity are measured using an absorption system.

TABLE 1
O₂ saturation capacities and P₉₅'s for synthetic O₂ carriers

| | O₂ saturation | |
|---|---|---|
| O₂ carrier | capacity* (ml (STP)/L) | P₉₅ (kPa) |
| PEI-Co | 1000 | 20.0 |
| Cobalt Porphyrins (CoPs) | 180 | 3.7-8.4 |
| Cobalt Porphyrin Complex (CoPlm) | 180 | 400 |

*O₂ saturation capacity contributed from the O₂ carrier in an aqueous solution of 0.008 mol/L.

Of these compounds, poly(ethyleneimine)-cobalt complex offers the best combination of excellent water solubility, high oxygen binding capacity and low cost. The compound can be synthesized by mixing poly(ethyleneimine) with cobalt chloride while controlling pH and ionic strength. The aqueous solution of this compound also has an oxygen/nitrogen absorption selectivity of about 700, which is high enough to yield an oxygen product having 99.5% purity using the above-described concentration of 0.008 mole per liter of water.

Because of the high selectivity of the oxygen-absorbing solvent, a substantial majority of the nitrogen remains on the first side 18 of the membranes 16 (suitably the bore side of membrane tubes 17) and is discharged through outlet 30 of membrane absorber 12 (FIG. 1). The oxygen-absorbing solvent absorbs the oxygen after it passes through the micropores 22 to the second side 20 of membrane 16 (suitably to the shell side of membrane tubes 17) to form an oxygen-rich carrier solution that exits the membrane absorber 12 through outlet 32. The oxygen-rich carrier solution is carried to a flash tank 34 during which the carrier solution partially transitions from zero or slightly positive pressure to a vacuum pulled from the membrane desorber 14, and the desorption of oxygen is initiated.

The oxygen-rich carrier solution is then carried to an inlet 36 of membrane desorber 14 and is channeled to a first side 40 of second membrane 38, which is suitably the shell side of a plurality of membrane tubes 44 (FIGS. 1, 3 and 5). The membrane desorber 14 can be configured similar to membrane absorber 12, with operation in reverse. A vacuum pressure is applied to the second side 42 of second membrane 38, suitably the bore side of membrane tubes 44. Oxygen desorbs irons the oxygen-rich carrier solution and passes through the micropores 41, from the first side 40 to the second side 42 of the second membrane 38. The desorbed oxygen can have greater than about 95% purity, suitably greater than about 99% purity. The desorbed oxygen product exits the membrane desorber 14 from the first side 40 through the outlet 48 for further processing and/or use. The oxygen-absorbing solution, having been stripped of its oxygen, exits the membrane desorber 14 through outlet 50 and is recycled to the solvent pump 26 and inlet 28 to the membrane absorber 12.

The second membrane 38 (which is suitably the plurality of membrane tubes 44) can be formed of the same materials, with the same pore sizes, thickness and other dimensions, as the first membrane 16 (which is suitably the plurality of membrane tubes 17). If the second membrane 38 is in she form of membrane tubes 44, then the range of diameters, wall thicknesses, packing density and total surface area can be the same as the first membrane 16 formed as membrane tubes 17. As explained above, the membrane desorber 14 can be configured substantially the same way as the membrane absorber 12, except that it operates in reverse.

In order to efficiently complete the desorption of oxygen from the oxygen-rich carrier solution, it is desirable to pull a vacuum on the second side 42 of the second membrane 38. The vacuum pressure should be strong enough to optimize the desorption of oxygen, yet not so strong as to force the liquid oxygen-absorbing solvent through the micropores 41 of the second membrane 38. The vacuum pressure pulled on the second side 42 of the second membrane 38 (which can be the bore side (if tubes 44) should he about 0.01 to about 0.5 kPa, suitably about 0.05 to about 0.1 kPa.

The embodiments of the invention described herein are presently preferred. Various modifications and improvements can be made without departing from the spirit and scope of the invention. The scope of the invention is defined by the appended claims and all changes that fall within the meaning and range of equivalents are intended to be embraced therein.

We claim:

1. A method of producing oxygen from an oxygen-containing gas comprising the steps of:
feeding a gas to the first side of a first membrane, the gas including nitrogen and oxygen;
feeding an oxygen-absorbing solvent to a second side of the first membrane;
passing the oxygen through the first membrane, from the first side to the second side of the first membrane, where the oxygen is absorbed by the oxygen-absorbing solvent to form an oxygen-rich carrier solution;
feeding the oxygen-rich carrier solution to a first side of a second membrane;
passing the oxygen from the oxygen-rich carrier solution through the second membrane, from the first side of the second membrane to a second side of the second membrane; and
recovering the oxygen from the second side of the second membrane.

2. The method of claim 1 wherein the gas is fed to the first side of the first membrane using pressure.

3. The method of claim 2, wherein the pressure is less than about 5 psig.

4. The method of claim 1, comprising one or more first membranes in the form of one or more tubes, the first side of each first membrane comprises a bore side of each of the one or more tubes, and the second side of each first membrane comprises a shell side of each of the one or more tubes.

5. The method of claim 1, wherein the first membrane is hydrophobic and comprises micropores through which molecules of the oxygen pass.

6. The method of claim 4, wherein each of the one or more tubes has a wall thickness not greater than about 0.25 mm and an outside diameter not creator than about 1.5 mm.

7. The method of claim 1, wherein the oxygen-absorbing solvent is selected from the group consisting of poly(ethyleneimine)-cobalt, cobalt porphyrins, cobalt porphyrin complexes, and combinations thereof.

8. The method of claim 1, wherein a vacuum pressure is applied to the second side of the second membrane.

9. The method of claim 8, wherein the vacuum pressure is less than about 0.5 kPa.

10. The method of claim 1, wherein the second membrane comprises one or more tubes, the first side of the second membrane comprises a shell side of each of the one or more tubes, and the second side of the second membrane comprises a bore side of each of the one or more tubes.

11. The method of claim 1, wherein the second membrane is hydrophobic and comprises micropores through which molecules of oxygen pass.

12. A method of producing oxygen from an oxygen-containing gas comprising the steps of:
providing a membrane absorber comprising a first plurality of membrane tubes, each membrane tube having a bore side and a shell side;
feeding a gas to the bore side of each of the first plurality of membrane tubes, the gas including nitrogen and oxygen;
feeding an oxygen-absorbing solvent to the shell side of each of the first plurality of membrane tubes;
passing the oxygen from the bore side to the shell side of each of the first plurality of membrane tubes, where the oxygen is absorbed by the oxygen-absorbing solvent to form an oxygen-rich carrier solution;
feeding the oxygen-rich carrier solution to a membrane desorber;
separating the oxygen from the oxygen-rich solution in the membrane desorber; and
recovering the separated oxygen from the membrane desorber.

13. The method of claim 12, wherein the first plurality of membrane tubes has a packing density of at least about 500 m²/m³.

14. The method of claim 13, wherein the packing density is about 1000 to about 5000 m²/m³.

15. The method of claim 12, wherein each of the first plurality of membrane tubes has a wall thickness not greater than about 0.25 mm and an outside diameter not greater than about 1.5 mm.

16. A method of producing oxygen from an oxygen-containing gas, comprising the steps of:
providing a first plurality of membrane tubes, each of the first plurality of membrane tubes having a shell side and a bore side;
providing a second plurality of membrane tubes, each of the second plurality of membrane tubes having a shell side and a bore side;
feeding a gas to the bore side of each of the first plurality of membrane tubes, the gas including nitrogen and oxygen;
feeding an oxygen-absorbing solvent to the shell side of each of the first plurality of membrane tubes;
passing the oxygen from the bore side to the shell side of each of the first plurality of membrane tubes, where the oxygen is absorbed by the oxygen-absorbing solvent to Hum an oxygen-rich earner solution;
feeding the oxygen-rich carrier solution to the shell side of each of the second plurality of membrane tubes;
passing the oxygen from the oxygen-rich carrier solution from the shell side to the bore side of each of the second plurality of membrane tubes; and
recovering Use oxygen born the bore side of each of the second plurality of membrane tubes.

17. The method of claim 16, further comprising the step of applying a pressure not greater than about 5 psig to the bore side of each of the first plurality of membrane tubes.

18. The method of claim 16, further comprising the step of applying a vacuum to the bore side of each of the second plurality of membrane tubes.
